(19) United States
(12) Patent Application Publication
(10) Pub. No.: US 2005/0098231 A1
(43) Pub. Date: May 12, 2005

(54) Control coupling for a delimbing and cutting apparatus

(76) Inventor: Arto Alftan, Tarttila (FI)

Correspondence Address: QUARLES & BRADY LLP, 411 E. WISCONSIN AVENUE, SUITE 2040, MILWAUKEE, WI, 53202-4497, US

(21) Appl. No.: 10/481,872

(22) PCT Filed: May 2, 2003
(86) PCT No.: PCT/FI03/00345

(30) Foreign Application Priority Data
May 3, 2002 (FI) 20020837

(51) Int. Cl. A01G 23/095

(52) U.S. Cl. 144/24.13

(57) ABSTRACT

A control coupling for a delimbing and cutting apparatus, provided for feeding means and for changing their feeding speed, and comprising at least two feed motors driven by a pressurized medium, each of the motors being intended to drive a feeding means which is intended to be placed against a tree trunk and to feed the tree trunk through said apparatus, a first channel, via which the pressurized medium can be supplied to the first feed motor and alternatively returned therefrom, and a second channel, via which the pressurized medium can be returned from the second feed motor and alternatively supplied to the same. Said feed motors are multi-capacity motors, wherein each motor has at least a first rotational capacity and at least a second rotational capacity as well as a first and a second basic connection for each capacity. The first basic connections of each motor are coupled together as a first connection , and the second basic connections of each motor constitute a second connection and a third connection, which are separate. The control coupling further comprises first valve means for coupling at least two different feeding speeds in operation, wherein the valve means are arranged to couple desired connections and channellings together.

### TECHNICAL FIELD OF THE INVENTION

The invention relates to a control coupling for a delimbing and cutting apparatus for feeding means and for changing their feeding speed.

### BACKGROUND OF THE INVENTION

For the processing of tree trunks, a harvester head, i.e. an apparatus for the delimbing and cutting of tree trunks, is used for the purpose of gripping an upright growing tree, cutting the tree and felling it, after which the tree trunk is delimbed and cut into pieces of fixed length by means of a sawing device. One known harvester head is disclosed in WO publication 00/15025. The harvester head is normally connected to the end of the boom assembly of a forest working machine. The har-vester head is connected to the boom assembly in an articulated man-ner, and it comprises the necessary actuator means, normally hydraulic cylinders and hydraulic motors, by means of which the position of the head and its different functions can be controlled. The harvester head comprises delimbing means which can be articulated in relation to the frame structure and which comprise delimbing blades for delimbing branches while the trunk is supported and forced through the appara-tus. The means used as the feeding means comprise a feed roll or a feed track assembly which is pressed against the trunk and pulls it through the apparatus. The harvester head also comprises cutting means, for example a chain saw, for cutting the tree trunk.

One known rubber feed pulley is disclosed in WO publication 95/01856, in which non-skid devices are connected by chains to the outer rim of the feed pulley. Another feed pulley is also presented in FI patent 102664. A shock absorbing feed pulley is presented in FI patent 97785, in which a rigid metal jacket with friction means is fitted on a gummy elastic rubber layer. One feeding device comprising a roll mat is disclosed in U.S. Pat. No. 3,669,161. The number of feed pulleys is normally two, but in WO 99/41972 and Fl patent 97340 there are four feed pulleys, wherein the feed pulley motors of the same side are cou-pled in series and the feed pulley motors of opposite sides are coupled in parallel. Two motors of opposite sides are coupled mechanically together to prevent the rotation of the feed pulleys at different speeds, particularly at high feeding speeds.

The feed motors have normally a fixed rotational capacity, wherein the feeding speed is constant and only depends on the volume flow sup-plied to the motor. Also variable-speed motors are known, but they are larger in size and normally require a reduction gear, wherein their size increases further. To keep the speeds equal in the different feed pul-leys, valves or auxiliary feed pulleys and their mechanical couplings must be used, wherein the size and weight of the harvester head are increased and the placement of the components becomes more diffi-cult. In some radial piston motors, the volume flow can be divided, for example, to one half of the pistons only, wherein the speed is doubled (and the torque and the tractive force are halved). In this case, a com-mon disadvantage is poor efficiency, when the pistons are not all in operation.

### SUMMARY OF THE INVENTION

It is an aim of the present invention to eliminate the above-presented drawbacks and to provide such a control circuit for the feeding means of the harvester head, which utilizes a motor of a given type and vari-ous couplings therein, to achieve multi-speed feeding in as simple a way as possible.

By means of the coupling according to the invention, it is possible to expand the ranges of tractive force and feeding speed of the respective feeding motor with a fixed volume. The coupling and the motors according to the invention can also be installed afterwards in the har-vester end, wherein the alternatives for the feeding speed in known apparatuses are increased. The motor used has a structure with a light weight compared with corresponding motors with adjustable speed.

A particular advantage is the coupling of the motors, whereby the speeds of two different feed pulleys can be locked together, wherein the aim is to prevent skid. The coupling can be used at high feeding speeds. The selection of the speeds is simple, because it can be implemented by on/off control. By suitable selection of the motor, speed steps are achieved which are smaller than in corresponding two-speed motors. With a suitable motor and different couplings, it is possible to achieve even a four-step feeding speed and an adjustment of even steps.

The invention utilizes a multi-capacity motor which is known, for exam-ple, from U.S. Pat. No. 6,099,273. The motor is a radial piston motor com-prising an input and output connection as well as an extra connection which can be used as an input or output connection. The motor also comprises a selector, i.e. a stem in a drilling, by means of which some of the pistons direct the used volume flow to the normal output connec-tion and the other pistons feed it to the auxiliary output connection. In this way, the motor has at least two different capacities (dual-capacity motor), wherein it comprises, in a way, two half-motors. Alternatively, the extra connection can be an auxiliary inlet connection, through which the volume flow is supplied to one of the half-motors. Because of the common shaft, however, the rotation speeds of the half-motors are the same. Said selector can also be missing, in which case the motor always has three connections available, one being connected to all the pistons and the two others being connected to specific separate pis-tons only, wherein the speeds to be achieved will depend on the cou-plings with which the motor is controlled.

U.S. Pat. No. 6,099,273 utilizes three said motors and the coupling there-between in the transmission of a vehicle. The most typical coupling of two separate motors is one in which two half-motors located in different motors are always coupled in series. Publication EP 1 026 025 A1 pre-sents examples of such series connections when they are applied in the wheels of a vehicle. U.S. Pat. No. 6,230,829 and EP publication 0 547 947 B1 also present a vehicle transmission utilizing said motor.

The basic principle of the invention is the use of said motors as feed motors at the harvester head and the possibility to connect them either in parallel or in such a way that only two half-motors are in series. By means of the connections, two different feeding speeds are achieved. Furthermore, the invention utilizes the connection of all the half-motors in series, wherein at least three different speeds can be used. When the rotational capacities of the half-motors differ from each other, four different feeding speeds are achieved. Furthermore, when the ratio of the rotational capacities of the half-motors is approximately 1:2, it is possible to achieve three speeds with a substantially equal change and a very fast fourth speed. Moreover, said adjustment of even steps is achieved in the whole rotational capacity of the motor.

### BRIEF DESCRIPTION OF THE DRAWINGS

The invention will be illustrated in the following description with refer-ence to the appended drawings, in which:

FIGS. 1 to 4 show the principles of coupling half-motors when they are coupled in parallel, partly in series with each half-motor separately, and when they are coupled in series;

FIGS. 5 to 7 show the more detailed structures of the control circuits to implement the couplings of FIGS. 1 to 4, when two different feeding speeds can be further achieved with the motors, and

FIGS. 8 and 9 show the more detailed structures of the control circuits to implement the couplings of FIGS. 1 to 4, when four differ-ent feeding speeds can be further achieved with the motors.

### DETAILED DESCRIPTION OF THE PREFERRED EMBODIMENTS

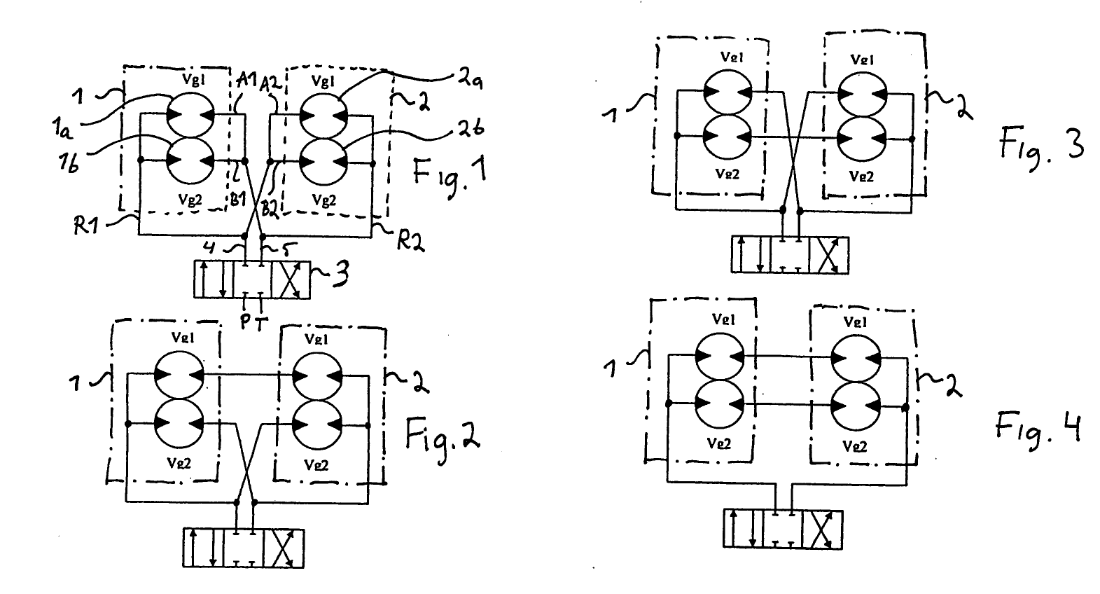

Table 1 shows three different motor models and example cases A, B and C of how the achievable rotational speed n of the feed roll varies according to the rotational capacity Vg of the two half-motors of the motor (Vg1 and Vg2) and when the feed volume flow remains the same. Furthermore, the feed force and speed of the feed roll depend on the pressure used and on the dimensions of the feed roll. The cou-pling 1 is a parallel coupling according to FIG. 1, and the coupling 2 is a series coupling of two half-motors as shown in FIG. 2. In the motor A, the ratio between the rotational capacities Vgl and Vg2 is 1:2, wherein the coupling of FIG. 3 yields 67% and 83% of the rotational capacity Vg of the coupling of FIG. 1 and FIG. 2, respectively, and the coupling of FIG. 4 yields the highest speed, wherein the rotational capacity Vg is 50% smaller than in the coupling 1 of FIG. 1. To achieve four different speeds, it is required that the rotational capacities Vgl and Vg2 in the same motor differ from each other, wherein their ratio differs from the value 1:1. With the ratio 1:2, equal changes are achieved in the rota-tional capacity Vg. Even if the ratio of the rotational capacities Vgl, Vg2 were 1:2 or variable, half-motors refer to all the different alterna-tives in this description.

TABLE 1

| Motor | A | B | C |
|---|---|---|---|
| Size | 943 cc | 1048 cc | 1404 cc |
| Vg1 (cc/r) | 314 | 419 | 561 |
| Vg2 (cc/r) | 629 | 629 | 843 |
| Coupling 1: | 100% | 100% | 100% |
| Rotational speed n1 | | | |
| Coupling 2: | 120% | 125% | 125% |
| Rotational speed n2 | | | |
| Coupling 3: | 150% | 143% | 143% |
| Rotational speed n3 | | | |
| Coupling 4: | 200% | 200% | 200% |
| Rotational speed n4 | | | |

FIG. 1 shows the coupling of the motors 1 and 2 in parallel, wherein the volume flow from the valve 6 is divided separately to the motors 1 and 2 (the connections A2, B2 and R1 are coupled together and to the channel 4) and wherein it also returns separately from the motors 1 and 2 (the connections Al, B1 and R2 are coupled together and to the channel 5). The half-motors 1a, 1b, 2a, 2b of the same motor 1, 2 are indicated with motor symbols drawn next to each other. At the same time, the common shaft is illustrated, as well as the fact that the half-motors always have a common rotational speed. Alternatively, the half-motors are indicated with a symbol which comprises two motor sym-bols within each other. Each half-motor comprises two basic connections which are for the supply and for the return of the volume flow. In the connections of FIGS. 1 to 4, either the first or the second basic connections of two half-motors are permanently joined to a con-nection R1 or R2, wherein the connection is preferably within the motor. In practice, the motors 1 and 2 are completely equal models.

Preferably, the motors 1, 2 comprise three connections which are always in use. Each motor 1, 2 comprises one return connection R1, R2 and two working connections A1, A2 and B1, B2. One should bear in mind that a pressurized volume flow can also be conducted to the return connection, and the volume flow of the half-motors can also be returned via the working connection. At the same time, the direction of rotation of the motors is reversed, which is the normal way of use when, for example during delimbing, the tree is reversed for some length, stopped, and the feeding is continued again. With the coupling alternatives of the two different motors 1, 2, it is possible to achieve the desired speed alternatives, even though the capacities Vgl, Vg2 of each motor 1, 2 were constant. The different coupling alternatives, which are illustrated in FIGS. 1 to 4, are implemented with different valve means, which are shown in FIGS. 5 to 9. In connection with FIGS. 2 to 4, reference numerals are used, which correspond to FIG. 1.

In FIG. 1, the common rotational speed n of the motors 1, 2 can be rep-resented by the formula n1=Q/2·(Vg1+Vg2), which is simultane-ously the rotational speed of the wheel guiding the feed pulley or feed roll, when no gears are used. Valve means 3, for example a spool valve with 3 positions, are used to select the direction of rotation of the motors 1, 2, wherein the volume flow is fed either to the channel 4 (in which case the return flow comes from the channel 5) or to the channel 5 (in which case the return flow comes from the channel 4). In the mid-dle position of the valve 3, the channels 4, 5 are closed and the motors are stopped. The valve 3 may also have a position, in which the motors 1, 2 are let on free circulation. The control circuit feeding the valve 3 is known as such, and it comprises at least a pressure connection P and a return connection T for the valve 3. Furthermore, the valve 3 com-prises a pressure connection P and a return connection T. Preferably, the valve 3 is a pressure-controlled proportional directional valve as shown in FIG. 7, comprising connections for the channels 4, 5, P and T.

The tree trunk is placed between the feed pulleys, wherein the direction of rotation of each feed pulley and the motor must be such that they always transfer the tree trunk in the same direction. Consequently, the motor 1 revolves, for example, counter-clockwise, wherein the motor 2 always revolves clockwise, and vice versa.

In FIG. 2, the rotational speed n of the motors 1, 2 can be represented by the formula n2=Q/(Vgl+2·Vg2), (n2>n1), wherein the connec-tions R1, B2 are coupled together (and to the channel 4), and the con-nections B1, R2 are coupled together (and to the channel 5), and the half-motors 1a, 2a (low capacities Vgl) are coupled in series (the con-nections A1, A2 being coupled together). The aim of the coupling is to tie the rotational speeds of the motors 1 and 2 to be equal. The feed pulleys (not shown in the figures) are coupled in a way known as such on the shaft of the motors 1, 2, which is shown in FIG. 7.

In FIG. 3, the rotational speed n of the motors 1, 2 can be represented by the formula n3=Q/(2·Vg1+Vg2), (n3>n2, when Vg1<Vg2, and n3=n2, when Vgl=Vg2), wherein the connections R1, A2 are cou-pled together (and to the channel 4), and the connections A1, R2 are coupled together (and to the channel 5), and the half-motors 1b, 2b(high capacities Vg2) are coupled in series (the connections B1, B2 being coupled together). The coupling corresponds to the coupling of FIG. 2, if Vg1=Vg2. The aim of the coupling is again to tie the rota-tional speeds of the motors 1 and 2 to be equal.

In FIG. 4, the rotational speed n of the motors 1, 2 can be represented by the formula n4=Q/(Vg1+Vg2), (n4>n3), wherein both the half-motors 1a, 2a (low capacities Vg1) and the half-motors 1b, 2b (high capacities Vg2) are coupled in series. Only the connection R1 is cou-pled to the channel 4, and only the connection R2 is coupled to the channel 5.

We shall now look at FIGS. 5 to 9 to discuss the different valve means by which the couplings of FIGS. 1 to 4 can be achieved. In the FIGS. 5 to 9, the different valve means are shown in the way in which they are coupled to the connections R1, R2, A1, A2, B1, B2 of FIGS. 1 to 4 or to the channels 4, 5.

FIG. 5 shows a control circuit with 2 speeds (the connections of FIGS. 1 and 2), which is implemented by means of a 2-position 4-way spool valve 6 with pressure control and spring return, whose inlet side is coupled separately to the connections A1 and B2 (the connection B2 communicating with the connections R1, 4), and whose outlet side is coupled separately to the connections A2 and B1 (the connection B1 communicating with the connections R2, 5). The valve 6 is controlled via a pressure channel 7 which, in turn, is controlled by a 2-position 3-way spool valve 8 with electrical control and spring return. By the positions of the valves 6, 8 shown in FIG. 5, it is possible to achieve the speed n1. In connection with the valves, the inlet and outlet sides refer to the direction of the volume flow when the volume flow is supplied into the channel 4, but when the direction of rotation is changed, the direction of the volume flow is changed as well.

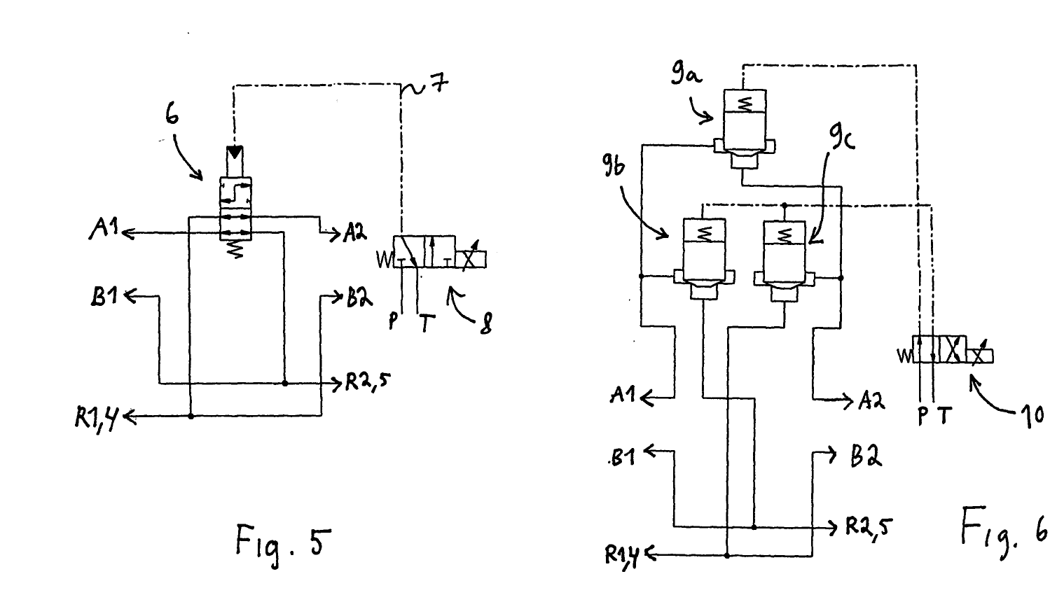

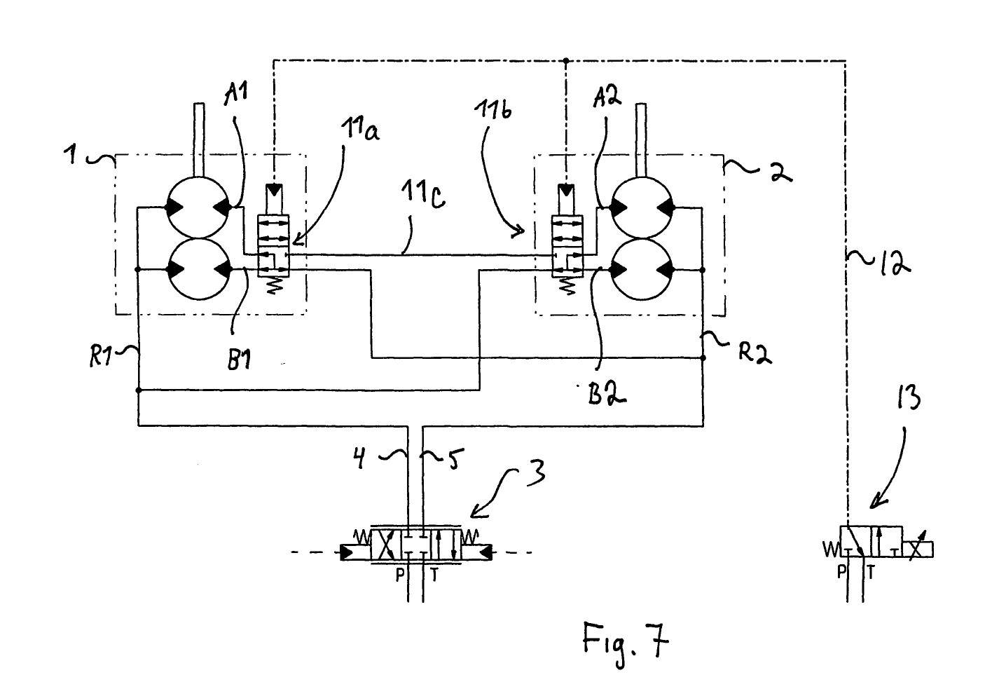

FIG. 6 shows a 2-speed (couplings according to FIGS. 1 and 2) con-trol circuit, which is implemented by means of cartridge valves with pressure control and spring return, namely 9a (connection A1 being coupled to the inlet side, which is so-called cartridge B-connection, and connection A2 being coupled to the outlet side, which is so-called car-tridge A connection), 9b (connection A1 on the inlet side and connec-tion B1, R2 and 5 on the outlet side) and 9c (connection R1, 4 being coupled to the inlet side, which is an A-connection, and connection A2 to the outlet side). A pilot valve is a 2-position 4-way spool valve 10 with electrical control and spring return, to whose outlet side valve 9a is coupled separately and valves 9b, 9c are coupled together. By the positions of the valves 9a, 9b, 9cand 10 shown in FIG. 6, it is possible to achieve the speed n1. The valves of FIGS. 5 and 6 are placed in a separate frame which is connected for example to the motor, or they are integrated in a valve block which is placed in the harvester head and in which also the other valves controlling the harvester head are.

FIG. 7 shows a 2-speed (connections of FIGS. 1 and 2) control circuit which is implemented by means of two 2-position 4-way spool valves with pressure control and spring return, namely 11 a (inlet side coupled to separate connections A1, B1 and outlet side coupled independently to connection R2 and simultaneously to channel 5) and 11b (outlet side coupled to separate connections A2, B2 and inlet side coupled inde-pendently to connection R1 and simultaneously to channel 4). The valves 11a, 11bare controlled via a pressure channel 12 which, in turn, is controlled by a 2-position 3-way spool valve 13 with electrical control and spring return. The outlet side of the valve 11 a and the inlet side of the valve 11b are connected by an independent channel 11c.

The valves 11a, 11b are integrated in the motor, wherein the valves are implemented as stems or selectors which are placed in a drilling which, in turn, is provided in the motor. Typically, the drilling comprises sepa-rate annular channels which are connected by channels provided in the stem in a desired way, when the stem is fitted in the drilling and it is moved into two different positions which correspond to the couplings of FIG. 7. The annular channels, in turn, communicate, for example in the motor 1, with the channels A1, B1 and R1 as well as with the dis-placement volumes of the pistons. The drilling of the motor is known as such, and it can be fitted with a stem which, in turn, is designed in such a way that the couplings according to FIG. 7 and the invention are possible. The final design and manufacture of the stem as such is easy for a man skilled in the art on the basis of this description, wherein a more detailed description of the stem will not be necessary.

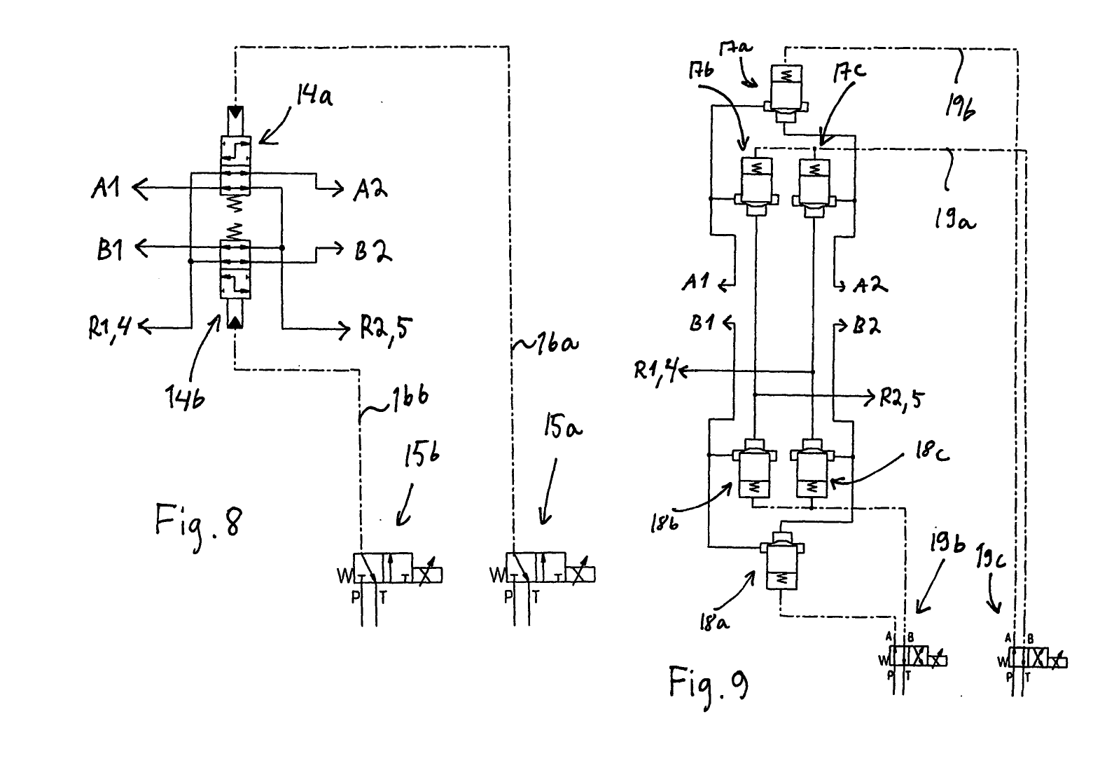

FIG. 8 shows a 4-speed (couplings of FIGS. 1 to 4) control circuit which is implemented by means of two 2-position 4-way spool valves with pressure control and spring return, namely 14a(the inlet side cou-pled separately to the connections A1, R1 and the outlet side sepa-rately to the connections A2, R2) and 14b(the inlet side coupled sepa-rately to the connections B1, R1 and the outlet side separately to the connections B2, R2). Each valve 14a, 14bis controlled via a pressure channel 16aor 16b, each closed by a 2-position 3-way spool valve 15aor 15bwith electrical control and spring return.

FIG. 9 shows a 4-speed (couplings of FIGS. 1 to 4) control circuit, which is implemented by means of cartridge valves with pressure con-trol and spring return, namely 17a(connection A1 on the inlet side and connection A2 on the outlet side), 17b(connection A1 on the inlet side and connections R2, 5 on the outlet side) and 17c(connection A2 on the outlet side, connections R1, 4 on the inlet side), as well as cartridge valves 18a(connection B1 on the inlet side and connection B2 on the outlet side), 18b(connection B1 on the inlet side and connections R2, 5 on the outlet side) and 18c(connection B2 on the outlet side and con-nections R1, 4 on the inlet side). The pilot valve for each series 17a-17cand 18a-18cis a 2-position 4-way spool valve 19a, 19bwith electrical control and spring return, their couplings corresponding to the couplings of FIG. 6. The cartridge valves are placed in a separate frame which is connected for example to the motor, or they are integrated in a valve block which is placed in the harvester head and which also accommodates the other valves controlling the harvester head.

In FIGS. 5 to 9, the connection R1 is coupled to the channel 4 and the connection R2 is coupled to the channel 5, wherein the connections and valves coupled to the connections R1, R2 simultaneously commu-nicate with the channels 4, 5 and further with the valve 3.

The invention is not limited solely to the above-presented embodiments used as examples, but it can be modified within the scope of the appended claims.

1. A control coupling for a delimbing and cutting apparatus, provided for feeding means and for changing their feeding speed and comprising at least:
two feed motors driven by a pressurized medium, each of the motors being intended to drive a feed means intended to be placed against a tree trunk and to feed the tree trunk through said apparatus,
a first channel, through which the pressurized medium can be supplied to the first feed motor and alternatively returned therefrom, when the direction of rotation of said feed motor is reverse, and
a second channel, through which the pressurized medium can be returned from the second feed motor and alternatively supplied into the same, when the direction of rotation of said feed motor is reverse,
wherein said feed motors are multi-capacity motors, wherein each motor has at least a first rotational capacity and at least a second rotational capacity as well as a first and a second basic connection for each capacity, for feeding or returning a volume flow;
wherein the first basic connections of each motor are coupled together as a first connection, and the second basic connections of each motor constitute a second connection and a third connection, which are separate; and
wherein the control coupling further comprises first valve means for coupling at least two different feeding speeds in operation, wherein the valve means are arranged to couple desired connections and channellings together in such a way that at least two of the following alternatives are available:
for the first feeding speed, the first connection of the first motor and the second and third connections of the second motor are coupled to the first channel, and the first connection of the second motor and the second and third connections of the first motor are coupled to the second channel; or
for the second feeding speed, the first connection of the first motor and the third connection of the second motor are coupled to the first channel, the first connection of the second motor and the third connection of the first motor are coupled to the second channel, and the second connection of the first motor is coupled in series with the second connection of the second motor; or
for the third feeding speed, the first connection of the first motor and the second connection of the second motor are coupled to the first channel), the first connection of the second motor and the second connection of the first motor are coupled to the second channel, and the third connection of the first motor is coupled in series with the third connection of the second motor; or
for the fourth feeding speed, the first connection of the first motor is coupled to the first channel, the first connection of the second motor is coupled to the second channel, the second connection of the first motor is coupled in series with the second connection of the second motor, and the third connection of the first motor is coupled in series with the third connection of the second motor.

2. The control coupling according to claim 1, wherein the first rotational capacities of the motors are equal to each other, the second rotational capacities are equal to each other, and the rotational capacities in each motor are different from each other.

3. The control coupling according to claim 1, wherein the control coupling comprises two speeds, wherein a first feeding speed and a second feeding speed are available.

4. The control coupling according to claim 1, wherein the control coupling comprises four speeds, wherein first, second, third and fourth feeding speeds are available.

5. The control coupling according to claim 1, wherein the first rotational capacities of the motors are equal to each other, the second rotational capacities are equal to each other, and the rotational capacities in each motor are equal to each other.

6. The control coupling according to claim 5, wherein the control coupling comprises three speeds, wherein the second and third feeding volumes are substantially equal and at least one of them is available, wherein the first feeding speed and the fourth feeding speed are also available.

7. The control coupling according to claim 1, wherein the control coupling also comprises second valve means, which are arranged in turn to couple one channel to the pressure line, to change the direction of rotation of the motors, wherein the other channel is simultaneously connected to a separate return line.

8. The control coupling according to claim 1, wherein the first valve means are integrated in said motors, in which also the first connection is integrated.

9. The control coupling according to claim 1, wherein the frame structure of each motor comprises a drilling provided with an annular channel which communicates with the first basic connection, and a separate annular channel which communicates with the second basic connection, wherein the drilling is fitted with a stem which can move in at least two positions and which is provided with channellings arranged to implement the couplings corresponding to the different feeding speeds.

10. The control coupling according to claim 1, wherein the delimbing and cutting apparatus comprises a valve block in which the valves controlling the apparatus are placed, wherein also the first valve means are integrated in said block.

11. The control coupling according to claim 1, wherein the feeding motors each drive a separate feeding means via a shaft, to which said feeding means is coupled for rotation.

12. The control coupling according to claim 1, wherein the feeding means is a wheel which is placed directly against the tree trunk, or a drive wheel which drives a track, a chain or the like which, in turn, is placed against the tree trunk.

13. The control coupling according to claim 2, wherein the control coupling comprises two speeds, wherein a first feeding speed and a second feeding speed are available.

14. The control coupling according to claim 2, wherein the control coupling comprises four speeds, wherein first, second, third and fourth feeding speeds are available.

15. The control coupling according to claim 8, wherein the frame structure of each motor comprises a drilling provided with an annular channel which communicates with the first basic connection, and a separate annular channel which communicates with the second basic connection, wherein the drilling is fifted with a stem which can move in at least two positions and which is provided with channellings arranged to implement the couplings corresponding to the different feeding speeds.

16. The control coupling according to claim 2, wherein the control coupling also comprises second valve means, which are arranged in turn to couple one channel to the pressure line, to change the direction of rotation of the motors, wherein the other channel is simultaneously connected to a separate return line.

17. The control coupling according to claim 5, wherein the control coupling also comprises second valve means, which are arranged in turn to couple one channel to the pressure line, to change the direction of rotation of the motors, wherein the other channel is simultaneously connected to a separate return line.

18. The control coupling according to claim 6, wherein the control coupling also comprises second valve means, which are arranged in turn to couple one channel to the pressure line, to change the direction of rotation of the motors, wherein the other channel is simultaneously connected to a separate return line.

19. The control coupling according to claim 10, wherein the control coupling also comprises second valve means, which are arranged in turn to couple one channel to the pressure line, to change the direction of rotation of the motors, wherein the other channel is simultaneously connected to a separate return line.

20. The control coupling according to claim 1 1, wherein the feeding means is a wheel which is placed directly against the tree trunk, or a drive wheel which drives a track, a chain or the like which, in turn, is placed against the tree trunk.
